(19) United States
(12) Patent Application Publication
(10) Pub. No.: US 2005/0114197 A1
(43) Pub. Date: May 26, 2005

(54) Consumer household product and service sales measuring system

(76) Inventor: Larry William Bell, Plano, TX (US)

Correspondence Address: LARRY BELL, 1016 EDGEFIELD DR, PLANO, TX, 75075, US

(21) Appl. No.: 10/720,901

(22) Filed: Nov. 24, 2003

(51) Int. Cl. G06F 17/60

(52) U.S. Cl. 705/10

(57) ABSTRACT

A mathematical system of measuring the consumer household demand for a consumer product or consumer service in a specified geographic location or socio economic group of consumer households. The measurement system was designed in such a way that it does not infringe on any personal information of the audience being measured. For the purpose of simplicity, any type of computer spreadsheet or database system software can manipulate the actual measurement numbers. The measurement system identifies a ratio of customer households in relationship to total households in a specific group or groups, in descending mathematical order, which household group or household groups actually contain the largest number of buying households in relationship to total households that have already purchased a specified product or specified service being measured.

### BACKGROUND OF THE INVENTION

In the field of advertising and marketing, manufacturers of products and services use a variety of ways to promote their products and services to the consumers who buy them. Some of these methods include, but are not limited to, newspaper, television, radio, billboards, and magazines. These mediums do not allow for the advertisers that promote their products and services through these vehicles to control (1) which consumer households actually get the advertisers message, (2) which households actually see the advertisement once they actually receive it or (3) measure which of these individual households or groups of households are actually buying the products or services of the advertiser.

A prime example of this would be a newspaper. When an advertiser buys advertising space in a newspaper, he never really knows which households actually subscribe to or receive the newspaper, nor does he know which individuals actually buy a newspaper from a newsstand or newspaper vending machine. Even if an individual reader really wants to buy an advertised product or service, if the reader does not receive a newspaper or does not open the paper to the right page, there is no possible way that the advertisers' message will actually get read by the individual reader. The same assessment can be applied to radio advertising, television advertising and magazine advertising.

The one advertising medium that gives the advertiser unlimited flexibility in the distribution of the advertising message is single piece direct mail. In order to institute a direct mail campaign, a mailing list is a key variable in the implementation of a successful campaign. Information that traditionally generates mailing lists is processed based on how information is acquired, stored and retrieved. An age and income list would be a prime example. It is not customary for an individual to enter a store and say “Hi, I'm 35 yours old and I make $85,000 per year”. The information in the list tells you how much money the individual makes and it also tells you how old the individual is. What it doesn't tell you is whether or not the individual needs to buy the product/service or whether or not the individual wants to buy the product or service.

Therefore, it can be determined that information on consumers that buy products and services is being stored and retrieved based on how the information is being acquired and not how consumers actually buy products and services. Unlike any other system of demographic measurement, our system of measurement is based on how a household group or combination of household groups actually buy, pay for and take delivery of products and/or services.

In an effort to identify the buying habits of individuals that buy consumer products and/or services, it is customary for marketers, demographics firms, advertising agencies and marketing firms to infringe on individual personal information stored and retrieved from a wide assortment of computer data banks around the world. One or more individuals or groups may have gathered this information for the purpose of creating demographic profiles or mailing lists. These individuals or groups will then sell this information to just about any firm or individual who can afford to pay for it. Individual consumers consider this sale, storage, retrieval and distribution of their personal information without their consent, written or otherwise, an infringement on their personal identity.

### BRIEF SUMMARY OF THE INVENTION

Buyers of consumer products and consumer services buy consumer products and consumer services because they perceive that they need them, that they want them and mostly because they can afford to buy them. Traditionally, information about individuals that buy consumer products and services is acquired through various means, then stored in a computer database or spreadsheet for future retrieval and processing based on how that information is acquired. These information and storage retrieval systems do not reflect how consumers actually buy products or services. This would include, but is not limited to, age, income, height, weight, male, female, short hair, long hair, rich, poor etcetera. Contrary to popular belief, consumers do no buy products and services because of how their information is stored and retrieved in a computer database. Buyers of consumer products and services do however buy these products and services because they need to buy a specific product or service, they want to buy that specific product or service and because they can afford to buy that specific product or service. The invention measures the level of need, desire and ability to buy a product/service based on which household addresses within a specified physical group or groups of households have previously purchased the products/services and cross references them with the total number of household addresses in the group or groups.

### DETAILED DESCRIPTION OF THE INVENTION

The invention is a computerized measuring system designed for measuring and identifying the sales of consumer products and/or services by individual household address and/or by predefined groups of household addresses and/or a combination of predefined groups. The function of the invention is to be able to identify future buyers of products and/or services based of previous sales performance of a product/service without infringing on the personal information of those buyers being measured. Therefore, the invention is designed to mathematically compute product and service sales into the marketplace by the density of total customer households already buying the product or service in relationship to total households within a predefined group of households. The percentage of customer households in relationship to total households isolates which groups of households have the highest propensity to buy a product or service in the order of sales and/or dollar volume importance. The measurement starts from (FIG. 1) where the percentage of overall customers in relationship to total households is the greatest and then diminishes to a smaller value for each group until finally there are no customers at all in a given group or groups.

These groups of addresses are segments (sections or segments) of an overall whole and are divided up by the dollar or economic value of the households contained in the overall group or groups. These groups or segments consist of households that are of approximately the same household value in relationship to all other households within the group being measured.

The actual computerized record of the physical address has additional data attached to the record that identifies other criteria, but the physical address is the primary identifier and measuring point for sales that have already taken place. The address was selected as the primary identifier because it is a piece of household information that is “not” associated with any particular individual, it almost never moves and it never dies. Therefore it becomes a fixed point of reference which to measure the sale of any consumer product or any consumer oriented service.

FIG. 2 demonstrates that the market segment is a fixed geographic location that has beginning and ending points on the north, south, east and west. In the measurement of product and/or service sales, all of the households in the sample used for measuring are accounted for. Unlike other demographic measurement systems that can not account for what is 100% of the total measurement universe, FIG. 2 demonstrates that every square inch of geography is accounted for by either a physical address, by undeveloped real estate or geography or a street name. Once the boundaries for a geographic area are originally set up, they are very rarely changed.

### BRIEF DESCRIPTION OF INCLUDED FIGURES

FIG. 1 illustrates the finished report in its mathematical format. Predefined columns in the report measure where the audience household group is located geographically and within which postal zip code. Also defined are the 5 different types of households being measured:
1.) Single Family (SF)
2.) Multi Family (MF)
3.) Duplex (DU)
4.) Condo (CO)
5.) Garden Homes (GA)

In addition, there are 7 economic levels of households being measured which are listed as follows:
1.) A Scale households=$400,000 in value or greater (Upper Up Scale)
2.) B Scale households=$325,000 to $399,999 in value (Mid Up Scale)
3.) C Scale households=$250,000 to $342,999 in value (Lower Up Scale)
4.) D Scale households=$175,000 to $249,999 in value (Above Average)
5.) E Scale households=$120,000 to $174,999 in value (Average)
6.) F Scale households=Less than $120,000 in value (Below Average)
7.) N Scale households=Households Not Rated In addition to the description listed above, there are total number of households and total number of customer households contained within the group. As described before, the “% of Total H/Holds” integer is computed by dividing “Total Customers” by “Total Households”.

FIG. 2 illustrates the bordering if a basic section or group of households.

FIG. 3 illustrates the identification of customer households and how they relate to the measuring of customer sales performance in an overall group of households.

FIG. 4 illustrates a sample zip code map segmented by socio economic level and by type of household.

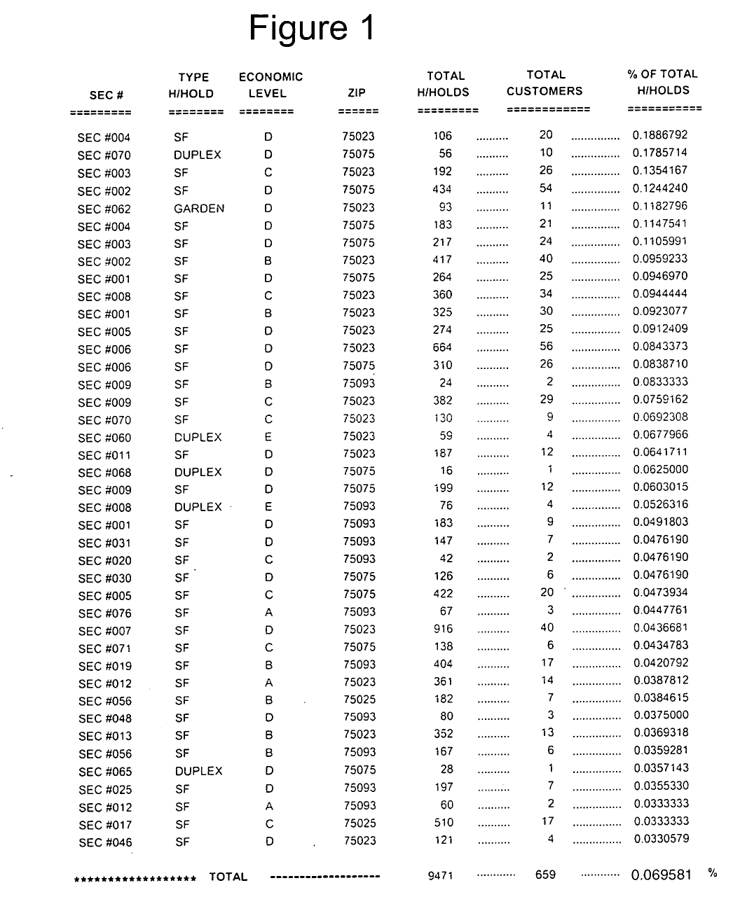

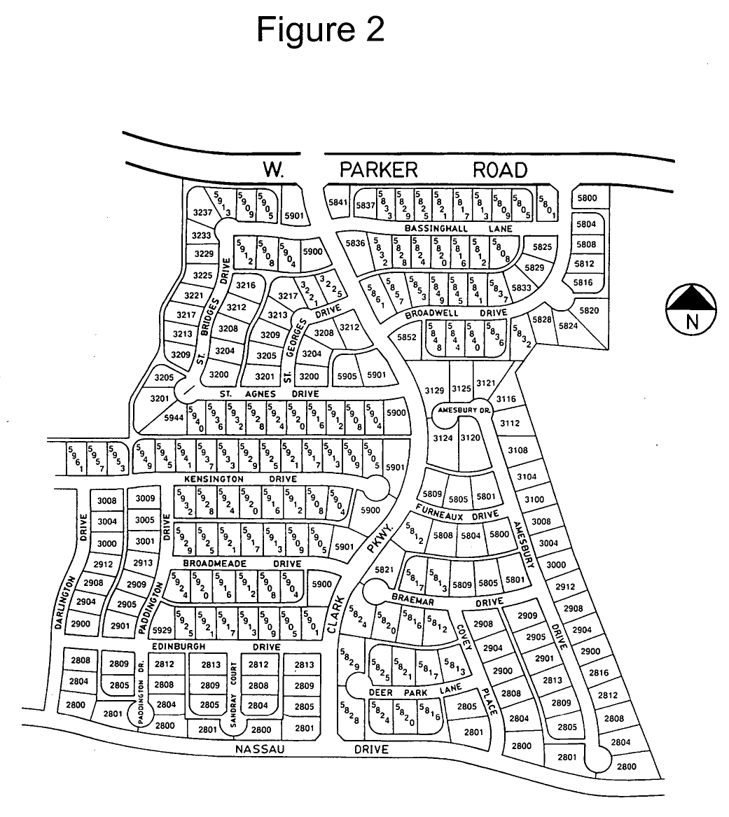

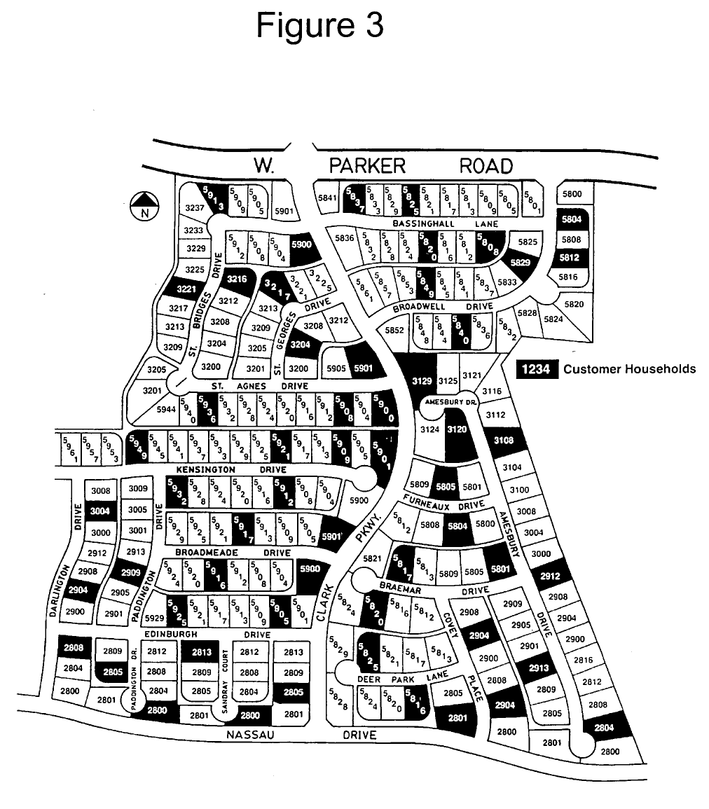

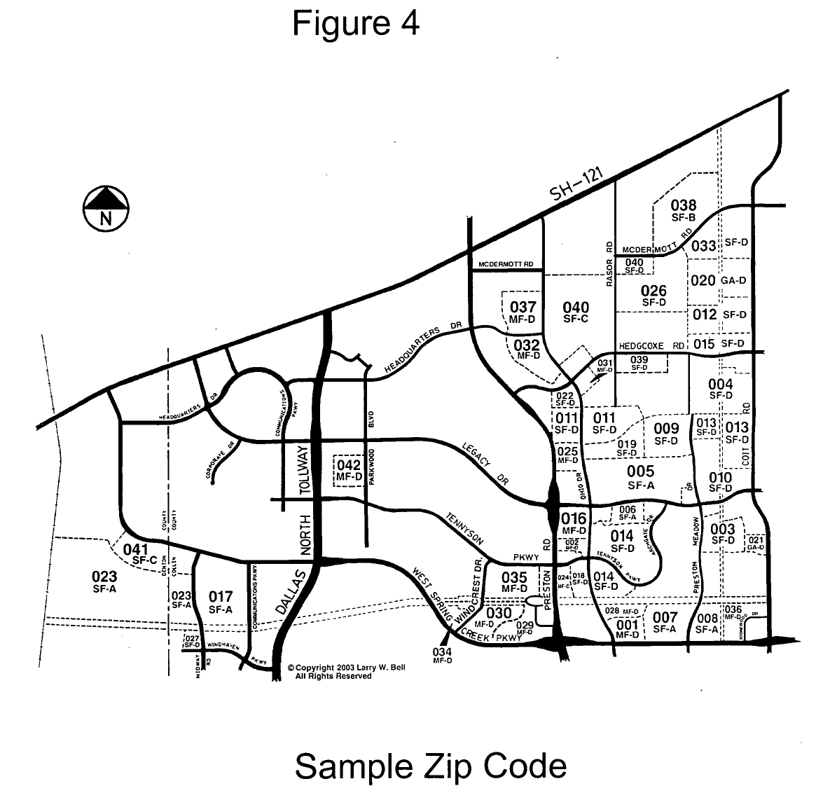

1. A mathematical system of measurement that has the propensity to track and measure sales of a consumer oriented product/service by physical household address in a predefined household group or combination of household groups that have previously purchased consumer oriented products/services and mathematically divide the total number of customer households for that product or service by the number of total households in the group to create a percentage of buying households.

2. A mathematical integer or combination of integers resulting from the calculation in paragraph c1 is then indexed in descending order from the largest integer to the integer of 0. The integer order automatically defines product or service demand by the percentage of density ratio between total customer households and the total number of households within the group.

3. A mathematical system of demographic measurement that does not infringe on the individual personal information of the consumers that purchase consumer oriented products and/or services.

4. A mathematical system of demographic measurement that isolates product and/or service demand in a predefined physical household group or socio economic group of households in relationship to total households in the group.

5. A mathematical system of household demographic measurement that measures sales for many types of consumer products and/or consumer service companies and not just one type of product/service.
